(19) United States
(12) Patent Application Publication
(10) Pub. No.: US 2007/0256939 A1
(43) Pub. Date: Nov. 8, 2007

(54) Methods and Apparatus for Electroerosion

(75) Inventors: Bin Wei, Mechanicville, NY (US); Michael Scott Lamphere, Hooksett, NH (US); Steven Robert Hayashi, Niskayuna, NY (US); Jeffrey Francis Wessels, Cincinnati, OH (US); Renwei Yuan, Shanghai (CN); Yuanfeng Luo, Shanghai (CN); Yimin Zhan, Shanghai (CN)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/770,207

(22) Filed: Jun. 28, 2007

Related U.S. Application Data
(63) Continuation-in-part of application No. 10/842,344, filed on May 7, 2004.

(51) Int. Cl. B23H 3/00

(52) U.S. Cl. 205/674; 205/686

(57) ABSTRACT

An electroerosion apparatus comprising: an electrode, a multiaxis machine, an electrolyte supply including a conduit for circulating an electrolyte, and a controller in operative communication with the multiaxis machine and configured for distributing intermittent multiple electrical arcs between the electrode and a workpiece. The multiaxis machine comprises a tool head configured to support and to spin the electrode, and a spindle configured to support a workpiece. The electrolyte comprises an anti-rusting agent, a defoaming agent, a lucent additive, a burst additive, a surface active medium, a lubricant, and water, and has a conductivity of about 0.1 milliSiemens to about 30 milliSiemens. In one embodiment, the method of electroerosion machining a workpiece comprises: creating relative motion between a spinning electrode and a workpiece; circulating an electrolyte around the spinning electrode, and distributing multiple electrical arcs between the electrode tip and the workpiece.

### CROSS-REFERENCE TO RELATED APPLICATION

The present application is a continuation-in-part of U.S. patent application Ser. No. 10/842,344 filed May 7, 2004, and incorporated herein in its entirety.

### BACKGROUND

This application relates generally to electromachining, and more particularly, to an electrolyte solution for electromachining.

Precision machining is commonly effected using multiaxis numerically controlled (NC) milling machines. The cutting tool is suspended from a tool head that typically has three orthogonal axes of translation and one or more additional axes of rotation corresponding therewith. The workpiece or part to be machined is fixedly mounted to a bed which may impart additional axes of translation or rotary movement thereto.

During operation, the NC machine is programmed in software for controlling the machining or cutting path of the tool for precisely removing material from the workpiece to achieve the desired final dimensions thereof. The typical milling machine includes a rotary cutting tool having a controlled feedpath for removing material from the workpiece in successive passes finally approaching the desired machined configuration.

Electrochemical (ECM) machining is a process in which cathode electrodes are specially built to achieve the desired final contours of the airfoils. An electrical current is passed through a liquid electrolyte in the gap between the electrodes and the workpiece for precisely removing small amounts of remaining material on the airfoils to achieve the desired final configuration thereof with substantially smooth surfaces. The ECM process is effected in another form of multiaxis NC machine in which the electrodes undergo complex three dimensional (3D) movement as they approach an individual rough airfoil from its opposite pressure and suction sides.

The ECM process is particularly advantageous for quick removal of the superalloy material to the substantially final smooth finish required for the airfoil on a bladed disk (or blisk) without undesirable damage thereto. Since the blisk workpiece requires multiple stages of manufacture and machining immediately prior to the forming of the airfoils therein considerable time and money are invested in the workpiece. And, as each of the multitude of airfoils around the blisk perimeter is machined, additional time and expense are invested which further increases the cost of the blisk.

Unacceptable damage to any one of the blisk airfoils or the supporting rotor disk itself during the various stages of manufacturing could render the entire blisk unusable for its intended use in a high performance gas turbine engine resulting in scrapping thereof with the attendant loss of time and expense.

Electrical discharge machining (EDM) is yet another process for machining material in gas turbine engine components. In EDM, a dielectric liquid is circulated between the electrode and the workpiece and electrical discharges are generated in the gap between the electrode and workpiece for electrically eroding material. The EDM process is typically used for drilling the multitude of small film cooling holes through the surfaces of turbine rotor blades and nozzle vanes. U.S. Pat. No. 6,127,642, assigned to the present assignee, is one example of an EDM machine having a slender electrode supported with lower and middle guides for reducing undesirable flexing thereof during the drilling process.

Both the ECM and EDM processes use electrical current under direct-current (DC) voltage to electrically power removal of the material from the workpiece. In ECM, an electrically conductive liquid or electrolyte is circulated between the electrodes and the workpiece for permitting electrochemical dissolution of the workpiece material, as well as cooling and flushing the gap region therebetween. In EDM, a nonconductive liquid or dielectric is circulated between the cathode and workpiece to permit electrical discharges in the gap therebetween for removing the workpiece material.

There continues to be a need for electrolyte compositions that enable a more consistent electroerosion process.

### BRIEF DESCRIPTION

Disclosed herein are embodiments of electroerosion apparatus and methods for use thereof.

In one embodiment, an electroerosion apparatus comprising: an electrode, a multiaxis machine, an electrolyte supply including a conduit for circulating an electrolyte, and a controller in operative communication with the multiaxis machine and configured for distributing intermittent multiple electrical arcs between the electrode and a workpiece. The multiaxis machine comprises a tool head configured to support and to spin the electrode, and a spindle configured to support a workpiece. The electrolyte comprises an anti-rusting agent, a defoaming agent, a lucent additive, a burst additive, a surface active medium, a lubricant, and water, and has a conductivity of about 0.1 milliSiemens to about 30 milliSiemens.

In one embodiment, the method of electroerosion machining a workpiece comprises: creating relative motion between a spinning electrode and a workpiece; circulating an electrolyte around the spinning electrode, and distributing multiple electrical arcs between the electrode tip and the workpiece. When the machining is performed at a rate of greater than or equal to about 2,000 mm³/min under the condition of peak current 280 amps, the resulting machined surface will be free from defects having a size of greater than or equal to 2 mm in diameter and 1 mm in depth, wherein the diameter is measured across the major axis and the depth is a maximum depth of the defect.

The above described and other features are exemplified by the following figures and detailed description.

### BRIEF DESCRIPTION OF THE DRAWINGS

Refer now to the figures, which are exemplary, not limiting, and wherein like numbers are numbered alike.

FIG. 1 is a schematic view of an exemplary embodiment of a distributed multiarc electroerosion apparatus for machining a workpiece supported therein.

FIG. 2 is a schematic representation of the electroerosion apparatus of FIG. 1 showing a portion of the workpiece being machined by the spinning electrode thereof.

FIG. 3 is another schematic view of the electroerosion apparatus with a further enlarged view of the spinning electrode tip during the electroerosion machining process.

FIG. 4 illustrates various arcs that can be formed when operating an electroerosion device.

### DETAILED DESCRIPTION

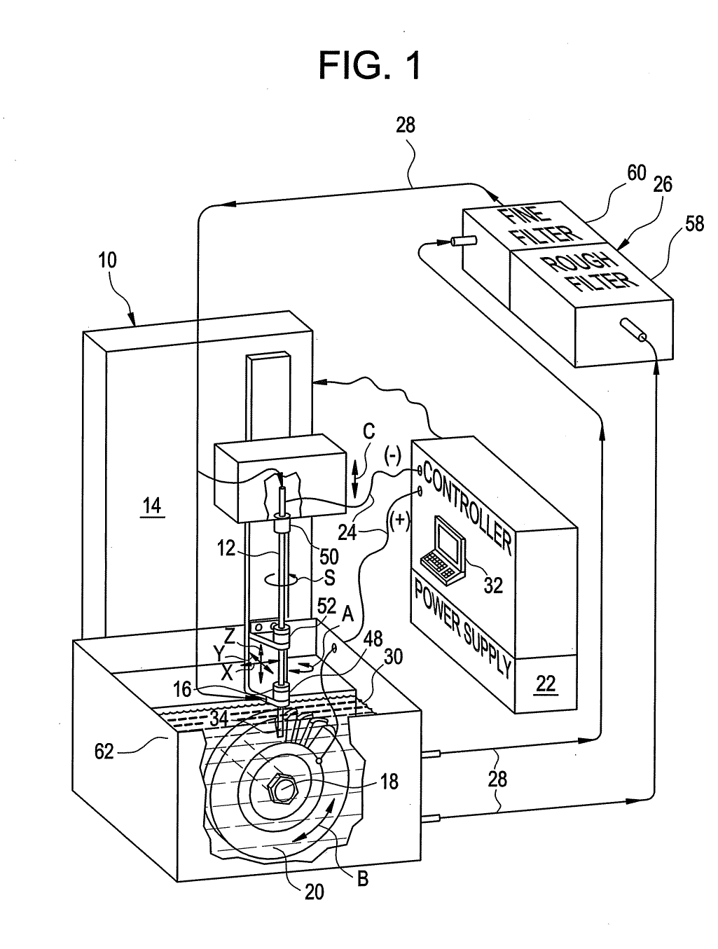

Illustrated schematically in FIG. 1 is an exemplary electroerosion machine or apparatus 10 including a tubular cutting tool or electrode 12. It should be understood that although the electrolyte will be described in relation to particular electroerosion apparatus, these are merely exemplary. The electrolyte can be employed in other electromachining apparatus. The illustrated apparatus includes a multiaxis, numerically controlled (NC) machine 14 which includes a tool head 16 that supports the electrode 12 for rotation or spinning “S” thereof, and multiple axes of movement during operation. The machine 10 also includes a suitable support table in the exemplary form of a rotary spindle 18, which supports a workpiece 20, which can optionally provide an additional axis of movement.

A direct current (DC) power supply 22 can be provided for carrying electrical power through the electrode 12 and workpiece 20 during operation. The power supply includes suitable electrical lead(s) 24 correspondingly joined, for example, to the electrode 12 as a cathode (−) and the workpiece as an anode (+). In alternate embodiments, the polarity can be reversed with an anode electrode and a cathode workpiece. Since the electrode 12 spins during operation, the electrical lead 24 therefore can be suitably joined thereto using an electrical slip ring or other connection as desired. Additionally, the lead for the workpiece can be directly attached thereto or to the supporting spindle 18 as desired.

An electrolyte supply 26 can be employed to circulate an electrically conductive liquid or electrolyte 30 through the electrode 12 during operation. The electrolyte supply 26 includes various conduit(s) 28 for supplying clean and cool electrolyte to the electrode while returning debris-laden electrolyte from the machining site.

The electrolyte can be a liquid with a sufficient conductivity to attain a desired removal rate (machine removal rate (MMR)), e.g., about 4,200 cubic millimeters per minute (mm³/min), wherein the removal rate is exclusive of the non-machining time such as tooling calibration and the like). For example, the electrolyte can have a conductivity of about 0.1 milliSiemens to about 30 milliSiemens, or, specifically, about 0.1 milliSiemens to about 5 milliSiemens, or, more specifically, about 2 milliSiemens to about 4 milliSiemens.

The electrolyte can comprise anti-rusting agent(s), defoaming agent(s), lucent additive(s), burst additive(s), surface active medium(s), and water. Possible anti-rusting agent(s) include triethanolamine, molybdate, tungstate, potassium oleate, potassium carbonate, sodium perborate, sodium citrate, trisodium phosphate, as well as combinations comprising at least one of the foregoing agents. Possible defoaming agent(s) include organic silicone defoaming additive such as polyether modified polysiloxane defoaming agent, long chain alcohol defoamer, as well as combinations comprising at least one of the foregoing agents. Possible lucent additive(s) include tri-sodium citrate, as well as combinations comprising at least one of the foregoing additives. Possible burst additive(s) include polyvinyl alcohol, rosin, saccharide, industry oil, as well as combinations comprising at least one of the foregoing additives. Possible surface active medium(s) can include sodium oleate, triethanolamine, emulsion (e.g., emulsifier OP-10 (i.e., octyl phenol ethoxylated OP-10 (C₈H₁₇C₆H₄O(CH₂CH₂O)10H)), as well as combinations comprising at least one of the foregoing mediums. Possible lubricant(s) include oil (e.g., industry oil 10#, 20#, etc.), potassium oleate, as well as combinations comprising at least one of the foregoing lubricants.

The components of the composition can be present in an amount that attains the desired properties. For example, conductivity of less than or equal to about 30 milliSiemens, or, more specifically, about 0.1 milliSiemens to about 15 milliSiemens, or, even more specifically, about 0.5 milliSiemens to about 10 milliSiemens, and yet more specifically, about 1 milliSiemens to about 5 milliSiemens. For example, conductivity of about 2.5 milliSiemens to about 4 milliSiemens, enables the attainment of a cycle time of less than or equal to about 20 min, and/or a surface roughness (Rₐ) of about 25 micrometers (μm) to about 40 μm. The composition can comprise about 8 weight percent (wt %) to about 35 wt % a anti-rusting agent(s), about 1 wt % to about 5 wt % defoaming agent(s), about 5 wt % to about 30 wt % lucent additive(s), about 5 wt % to about 20 wt % burst additive(s), about 0.5 wt % to about 5 wt % surface active medium(s), about 1 wt % to about 20 wt % lubricant(s), balance water, based upon a total weight of the composition. More specifically, the composition can comprise about 20 wt % to about 30 wt % a anti-rusting agent(s), about 2 wt % to about 4 wt % defoaming agent(s), about 16 wt % to about 22 wt % lucent additive(s), about 5 wt % to about 10 wt % burst additive(s), about 0.5 wt % to about 2 wt % surface active medium(s), about 5 wt % to about 10 wt % lubricant(s), balance water, based upon a total weight of the composition. For example, the composition can comprise about 5 wt % to about 10 wt % a triethanolamine, about 0.5 wt % to about 2 wt % sodium perborate, about 5 wt % to about 10 wt % sodium molybdate, about 4 wt % to about 8 wt % potassium oleate, about 4 wt % to about 8 wt % potassium carbonate, about 2 wt % to about 5 wt % silicone defoaming agent(s), about 15 wt % to about 20 wt % tri-sodium citrate, about 5 wt % to about 10 wt % polyvinyl alcohol, about 0.5 wt % to about 2 wt % emulsifier OP-10, about 5 wt % to about 8 wt % industrial oil, balance water, based upon a total weight of the composition. When used, the electrolyte composition can be diluted with water. For example, the electrolyte composition can be diluted at a weight ratio of water to electrolyte of about 50:1 to about 15:1, or, more specifically, about 30:1 to about 25:1. It can also optionally be heated, e.g., when forming the electrolyte composition, to further enhance mixing of the constituents.

A digitally programmable electrical controller 32 can be in operable communication with the NC machine 14 for controlling its operation, and additionally in operable communication with to the DC power supply 22 for also controlling its operation and for coordinating relative movement between the electrode and the workpiece during the electroerosion machining process. The controller 32 can take any form and can includes a central processing unit (CPU) and all attendant memory and data handling systems (e.g., that can be programmed using suitable software for controlling operations of the apparatus). A monitor and keyboard can be provided with the controller for use both by an operator in controlling the electroerosion machining process, as well as by a programmer for initially setting up the machine for specific forms of workpieces.

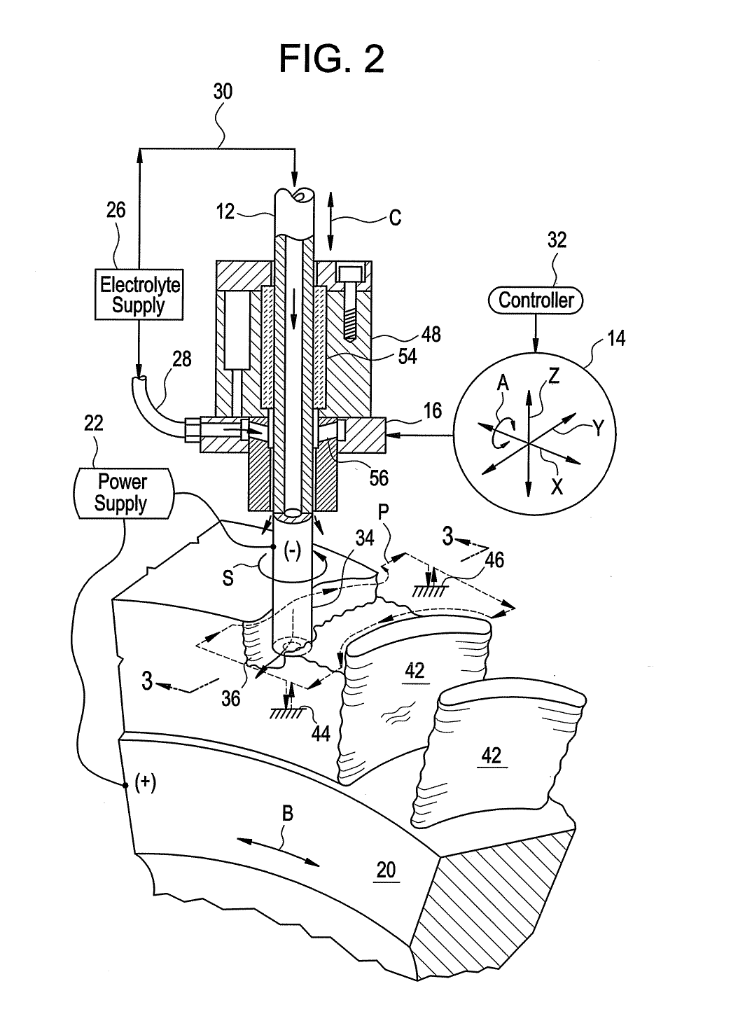

The electroerosion apparatus 10 is illustrated in more detail in FIG. 2 in association with the corresponding process or method of electroerosion of the workpiece 20. The process includes feeding the spinning tubular electrode 12 along a feedpath (P) across the workpiece 20 (e.g., which is rotated and moved along a multi-axis). The electrolyte 30 is circulated through the spinning electrode and out through the tip 34 thereof closely adjacent to the workpiece being machined. The spinning electrode 12 is powered by the power supply 22 as a cathode while the workpiece is powered as an anode for electroeroding a corresponding slot 36 through the workpiece corresponding generally with the size of the cutting electrode itself.

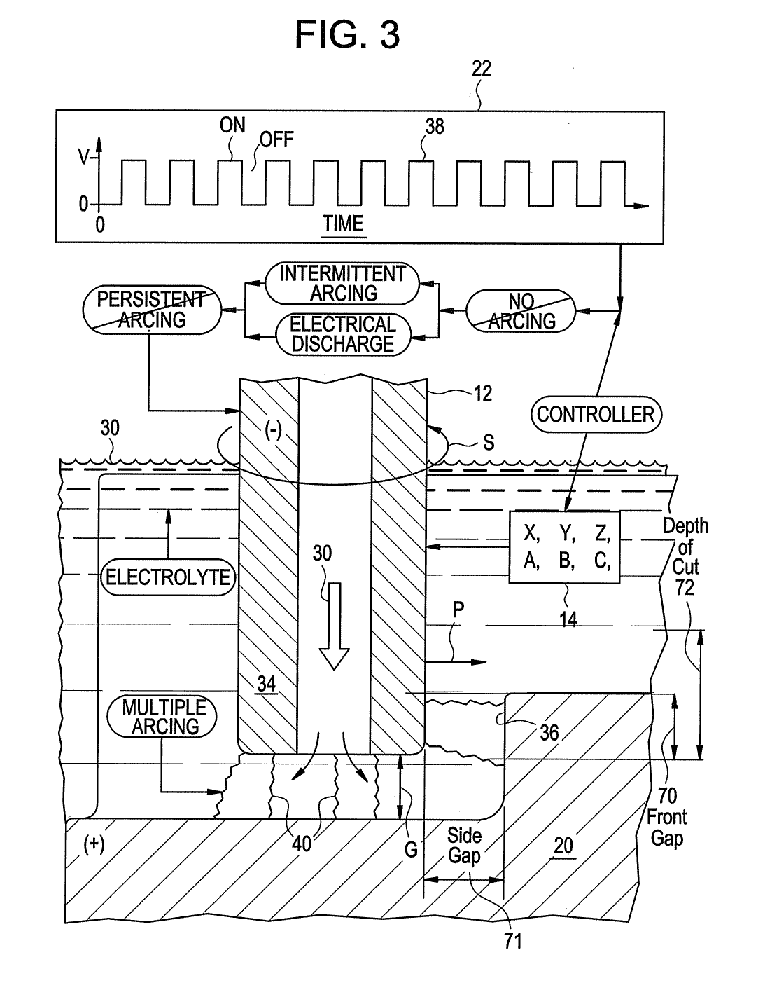

FIG. 3 illustrates further enlarged the tip end of the electrode 12 as it electroerodes the slot 36 in the workpiece. In particular, the controller 32 is specifically configured for powering the spinning electrode 12 with a DC pulsed train or waveform 38 which has the technical effect of distributing spatially multiple electrical arcs 40 between the electrode tip 34 and the workpiece 20 for controlled electroerosion machining thereof. As the spinning electrode 12 travels along the programmed feedpath “P” through the workpiece, electrical power is carried through the electrode and the electrolyte in the small gap “G” maintained between the electrode tip and the workpiece for electrically eroding material from the workpiece to form the corresponding slot.

As indicated above, the production of electrical arcs in EDM and ECM processes is strictly prohibited therein due to the associated damage therefrom. In EDM and ECM processes, the corresponding electrical controllers thereof include circuits specifically configured for detecting arcing or incipient arcing, to thereby prevent or terminate arcing during operation.

The exemplary electroerosion process illustrated schematically in FIG. 3, however, intentionally effects electrical arcing (e.g., electrical arcing that is distributed spatially over the electrode tip engaged in the machining process) during operation to substantially increase the rate of material removal from the workpiece. In the illustrated embodiment, the most arcing 40 occurred in front gap 70, between the end face of the electrode tip 34 and the workpiece 20, and some arcing 40 occurred in the side gap 71 between the side of electrode tip 34 engaged in the machining process and workpiece 20. The side arcing is affected by the depth of cut 72 and it will directly influence the machined surface 36 such that, if the side arcing is consecutive arcing, it could form a crater in the machined surface. The optimum depth of cut will have a high material removal rate (exclusive of set up times (e.g., calibration), with the specific number dependent upon the particular current (e.g., greater than or equal to about 2,000 cubic millimeters per minute (mm³/min) under the condition of peak current 280 amperes (amp), or, specifically, greater than or equal to about 3,000 mm³/min at the peak current of 280 amps, or, more specifically greater than or equal to about 4,000 mm³/min at the peak current of 280 amps, and even up to about 5,000 mm³/min at the peak current of 280 amps), and will produce a better machined surface. For example, the surface will be free from defects (i.e., craters or gouging), having a size of greater than or equal to 2 mm in diameter and 1 mm in depth, and can even be free from craters or gouging having a size of greater than or equal to 1.5 mm in diameter and 0.8 mm in depth, wherein the diameter is measured across the major axis, and the depth is the maximum depth of the defect (crater/gouge).

The conductivity and constituent of the electrolyte will affect the arcing distribution or normal discharging ration during machining, and will also affect the machined surface. When the conductivity is lower, the material removal rate will be lower and machined surface becomes worse due to a lack of ECM reaction. However, when the conductivity is too high, the machining process is difficult to control and can become unstable.

The controller 32 is configured for controlling the power supply 22 to power the spinning electrode with the DC pulse voltage waveform 38, while also controlling the multiaxis machine 14 to adjust the electrode travel through the workpiece and effect temporally intermittent, or transient, multiple electrical arcs between the electrode and workpiece.

FIG. 3 also illustrates schematically that the controller 32 is configured between two extremes of operation to prevent no-arcing between the electrode and workpiece as represented by the no-arcing box with the diagonal line therethrough, and to prevent persistent or steady-state arcing similarly represented by the box with the diagonal line therethrough.

As indicated above, no-arcing operation is desired and achieved in ECM and EDM electroerosion. And, persistent or continual arcing is undesirable in the ECM and EDM processes for the attendant thermal damage to the workpiece associated with a large recast or HAZ layer.

However, with the present process, by both spatially and temporally distributing multiple electrical arcs between the spinning electrode and workpiece, electroerosion material removal can be substantially enhanced, with a removal rate being substantially greater than that for both EDM and ECM, while minimizing the undesirable recast layer.

As shown schematically in FIG. 3, the DC pulse waveform 38 effects a train of on and off DC voltage pulses to power the electroerosion process through the electrode tip. The electrical power is carried through the electrolyte 30 in the gap G between the electrode tip and the workpiece. The generation of the electrical arcs is random from pulse to pulse, but is nevertheless statistically repetitive and statistically controllable.

Accordingly, control of the power supply can be coordinated with the feedpath travel “P” of the electrode 12 for effecting intermittent multiple electrical arcs 40 between the electrode tip 34 and workpiece temporally alternating with electrical discharges between the electrode and workpiece without electrical arcing. In this way, the increase of material removal attributed to the multiple electrical arcs can be balanced with the resulting recast layer by alternating arcing with non-arcing electrical discharges. This balance can be determined for particular workpieces and particular machining processes empirically using both analysis and a series of test machining.

The process illustrated in FIG. 3 includes the use of an electrolyte, instead of a dielectric, in the gap between the electrode and workpiece, and spinning the electrode in the electrolyte. In this way, the spinning electrode is conducive to dispersing multiple, simultaneous electrical arcs between the electrode and workpiece, instead of a single electrical discharge arc, and effectively increases the electroerosion cutting area. And high spinning speed (e.g., greater than or equal to about 1,600 revolutions per minute (RPM)) of the electrode could also break the random consecutive arc. Heat from the electroerosion process is therefore distributed over the entire surface area of the spinning electrode tip. Correspondingly, wear of the electrode tip itself is also distributed around its circumference.

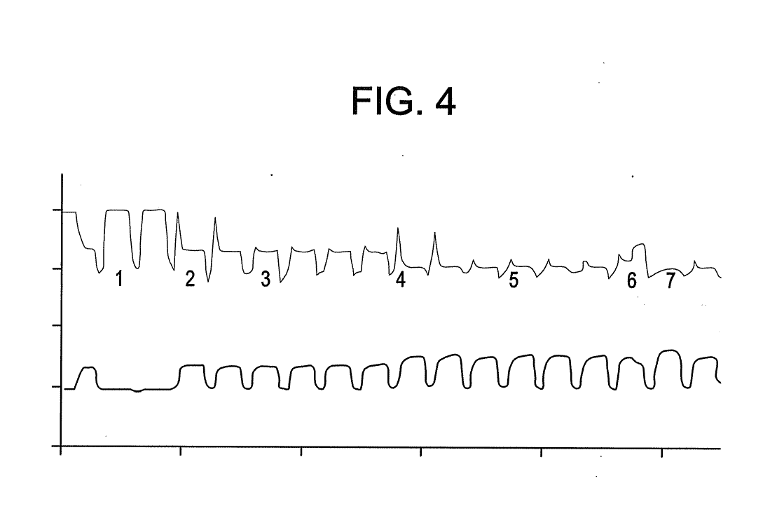

Referring to FIG. 4, various arcs and operating conditions are illustrated. Section 1 illustrates an open circuit where there is no discharging and the voltage is equal to the open voltage, while the current is 0A; known as an open circuit. This can occur, for example, when the gap between electrode and workpiece is large. Section 2 illustrates a normal discharge with ignition delay, which happens between the electrode and the workpiece when they are close enough; e.g., as in ECDM processes. Section 3 illustrates discharge without ignition delay, which also happens between the electrode and the workpiece when they are close enough; e.g., in ECDM processes with conductive electrolyte. Sections 4 and 5 illustrate an arc with ignition delay and without ignition delay, respectively. These arcs occur when the gap between the electrode and the workpiece are even closer than for the normal discharge. When these kind of arcs lasts a short time (less than 50 milliseconds (ms)) it doesn't damage the machined surface; know as transient arc. However, when they last more than 50 ms, they could damage the machined surface (e.g., could form a crater-like defect on the machined surface); known as consecutive arc. In ECDM, most arcs are without ignition delay. For example, when the consecutive arc duration time is greater than or equal to 200 ms bigger craters can be formed. Section 6 illustrates a deformed wave pattern (combined arc and discharge), which is the waveform between normal discharging and arc, and which only happens randomly. Section 7 illustrates a short circuit, which happens when the gap between the electrode and the workpiece is zero. Short circuiting can damage the workpiece due to the high temperatures generated, and it tends to slows down the machining cycle time.

Furthermore, clean and cool electrolyte 30 can channeled internally through the tubular electrode and out the orifice in the center of the electrode tip for providing clean and cool electrolyte in the machining gap “G” for promoting stability and distribution of the multiple electrical arcs, or otherwise introduced to the electrode to clean and/or cool. The electrolyte can also remove the erosion debris from the machining process.

Quite significantly, a substantial increase in the electrical current can be used with the spinning electrode with a correspondingly lower peak current density due to the generation of the distributed multiple arcs, which combine to substantially increase the rate of material removal relative to ECM and EDM machining processes.

The tool head 16 shown in FIG. 1 is preferably supported in the multiaxis machine 14 with three axes X,Y,Z of linear and orthogonal translation, and axis(es) of rotation “A” such as that found around the linear axis Z. The X axis is parallel to the plane of the exemplary workpiece 20 and normal to the spindle axis. The Y axis is parallel to the spindle axis and is in a horizontal plane with the X axis, while the Z axis is vertical. While in the case of FIG. 1 the electrode is a vertical style, other styles can be used, such as a horizontal style, like horizontal milling center.

The tool head 16 can be mounted in the machine in any manner capable of achieving these exemplary axes of movement, and is typically effected using suitable screw driven carriages powered by corresponding electrical servomotor(s). The various servomotors for the movement axes are operatively joined to the controller 32 which coordinates the movement thereof to in turn control the feedpath P of the electrode tip during operation. In this way, the electrode tip may follow a precise 3D feedpath through the workpiece as desired for machining complex 3D contours in the workpiece.

Correspondingly, the spindle 18 illustrated in FIG. 1 is supported in the multiaxis machine 14 with a rotary axis “B” of movement effected by a corresponding servomotor. The “B” axis servomotor is also operatively joined to the controller 32 for preferably periodic rotational indexing of the exemplary workpiece 20 as required during operation.

For example, the exemplary workpiece illustrated in FIG. 1 is in the form of an annular blisk blank, and the spindle 18 is configured for supporting the blank 20 coaxially thereon. The spindle 18 is in the form of a shaft, and the blisk blank has a center bore which can be mounted using a suitable fixture fixedly attached to the spindle for rotation therewith during operation.

The controller 32 is correspondingly configured for driving the spinning electrode 12 along arcuate feedpaths P as illustrated in more detail in FIG. 2 axially through the outer perimeter of the blisk blank 20 for forming rough airfoils 42 extending radially outwardly from the perimeter of the workpiece relative to the centerline axis of the supporting spindle.

Since electroerosion cutting is limited to the tip region of the electrode 12 as illustrated in FIGS. 2 and 3, the controller 32 is further configured for driving the electrode 12 in successively radially deeper feedpaths axially through the workpiece 20 for electroerosion machining discrete rough airfoils 42 in turn in the blank. The slots 36 are therefore machined radially deeper from the outer perimeter of the workpiece for the desired full height of the resulting rough airfoils 42, which airfoils 42 are formed after machining complete slots on opposite sides thereof.

The rough airfoils 42 so machined include sufficient additional material thereon for undergoing a subsequent machining operation for removing the rough finish thereof and the thin recast layer for achieving the final dimension and smooth surface finish for the final airfoils of the blisk.

As the electrode 12 electroerodes material from the workpiece 20 as illustrated in FIG. 3, it correspondingly wears and become shorter in length. Accordingly, the controller 32 is preferably additionally configured for compensating for this wear of the electrode which decreases the length thereof. For example, the controller can be configured for calculating wear per machining pass of the electrode and correspondingly adjusting the radial position of the electrode as the electrode completes each of its feedpath passes through the perimeter of the workpiece. The small gap “G” between the electrode tip and workpiece can be maintained substantially constant during the machining process, but is dynamically varied by the controller to control efficacy and stability of the multiarc erosion process.

As shown in FIG. 2, the multiaxis machine 14 can include reference plane(s) 44,46 (which could be a small and/or curve surface, and/or a flat plane) associated with the length of the electrode 12. Correspondingly, the controller 32 can then be further configured for touching the electrode tip 34 against the reference plane prior to or immediately after each of the successive feedpath through the workpiece, or at other intervals (e.g., touching the tip every X layers (3, 4, etc.) instead of each layer, such that the calibration time will be reduced), to calibrate the radial position of the electrode tip. In this way, an accurate indication of the position of the electrode tip, and corresponding length of the electrode, can be stored in the controller for each pass of the electrode to improve the accuracy of the wear compensation of the electrode during machining. The tip position may otherwise be detected by other suitable means, such as by laser detection.

The electrode 12 illustrated in FIG. 1 is slender or elongate, and is relatively long and thin with a suitable diameter for the intended workpiece. Sufficient length is provided in the electrode for compensating for the wear of the electrode during operation which reduces its length, with the electrode having a suitable length to diameter ratio, e.g., initially greater than about 5.

Accordingly, the tool head 16 illustrated in FIG. 1 includes a lower tubular guide 48 for coaxially supporting the lower end of the electrode 12, with the lower distal tip 34 of the electrode being suspended therebelow and directly atop the workpiece. The lower guide supports the lower end of the electrode for rotary movement therein.

Correspondingly, the multiaxis machine 14 further includes a rotary collet or chuck 50 suitably joined to an upper extension of the tool head 16 above the lower guide for supporting and rotating or spinning the opposite top or proximal end of the elongate electrode 12. In this way, the top of the electrode is mounted in the spinning chuck, and the bottom of the electrode is mounted through the lower guide for permitting spinning thereof during operation.

Since the electrode should be sufficiently long for allowing sufficient time for electroerosion machining prior to the consumption thereof, the tool head 16 illustrated in FIG. 1 can also include a middle tubular guide 52 disposed longitudinally between the upper chuck 50 and the lower guide 48. The middle guide 52 coaxially supports an intermediate portion of the electrode 12 for restraining wobbling or radial flexing thereof during operation. In this way, accurate position of the electrode tip can be maintained during the machining process by maintaining the long, spinning electrode straight.

The chuck 50 illustrated in FIG. 1 can be mounted on the common tool head 16 for selective elevation movement “C” thereon to push or index the electrode 12 downwardly through the lower guide 48 as the electrode wears at the tip 34 thereof. The chuck can be mounted in a suitable carriage powered by another servomotor for precisely controlling the vertical elevation of the proximal end of the electrode, and in turn controlling the vertical location of the lower electrode tip.

Accordingly, as the tip wears during operation, the electrode can be continually indexed lower as its length is reduced. When the electrode becomes too short for practical use, the machining process is temporarily interrupted for replacing the electrode with a new and longer electrode, and repositioning the chuck 50 to the top of its travel path.

The lower guide 48 is illustrated in a preferred embodiment in FIG. 2 and includes a ceramic bushing 54 coaxially mounted therein in a suitable bore for coaxially supporting the electrode 12 extending therethrough. The ceramic bushing is wear resistant to the rotating electrode for ensuring its accurate support during spinning operation.

The lower guide can be made from multiple parts, including a main body in which the ceramic bushing 54 can be mounted, and covered by a removable lid fastened thereto by bolts. A lower body extends downwardly from the main body of the lower guide through a corresponding aperture in the tool head 16 for retention thereon.

The lower guide can be formed of stainless steel to resist corrosion from the electrolyte, and has a center bore spaced suitably outwardly from the electrode to provide a small radial gap therebetween, with the electrode being radially supported by the close fitting ceramic bushing 54 disposed therearound.

The lower guide may have a length to diameter ratio greater than about 3 for ensuring stable support of the lower end of the electrode during operation. The middle guide 52 can be similarly configured with a trapped ceramic bushing therein for supporting the intermediate portion of the electrode during operation. The middle guide as illustrated in FIG. 1 is suitably supported from an additional arm of the tool head 16, which is adjustable in elevation as desired for minimizing any wobbling of the slender electrode during operation.

As further illustrated in FIG. 2, the lower guide 48 preferably also includes a row of radial or inclined inlet holes 56 extending laterally therethrough to the center bore thereof, and joined in flow communication to the electrolyte supply 26. The supply conduit 28 can be fixedly joined to the lower arm of the tool head 16 through which the lower guide 48 is mounted to provide a common annular manifold around the row of inlet holes 56 for supplying electrolyte thereto under suitable pressure.

In this way, additional electrolyte is channeled through the lower guide and around the tip of the spinning electrode for external flushing of the electrode tip directly above the slot being machined by the electrode tip itself.

As shown in FIG. 1, the proximal end of the electrode 12 is suitably joined to the conduit 28 in flow communication with the electrolyte supply 26 for channeling the electrolyte through the electrode. The electrolyte is internally channeled through the electrode and discharged out the bore of the electrode tip to locally flush the gap between the tip and workpiece during operation.

The electrolyte supply 26 illustrated in FIG. 1 includes various pipes or conduits for circulating the electrolyte to and from the cutting region of the spinning electrode, and corresponding pumps therefore. Preferably, the electrolyte supply includes two stage filters 58,60 for successively filtering from the electrolyte relatively large or rough and relatively small or fine erosion debris generated during the electroerosion of the workpiece.

The electrolyte supply preferably also includes a work tank 62 containing the spindle 18 and workpiece mounted thereto. The tank is sized for being filled with electrolyte 30 in a pool to submerge the workpiece 20 and the electrode tip during the electroerosion process. The bottom of the tank can be suitably connected to the rough filter 58 for removing the large debris particles from the electrolyte. The rough filter is in turn joined in flow communication with the fine filter 60 for removing even smaller debris particles. And, the upper portion of the tank 62 can be directly joined to the fine filter and bypassing the rough filter.

The rough and fine filters 58,60 may have any suitable configuration, such as a filtering conveyor belt in the rough filter 58, and rolled paper filters for the fine filter for effectively removing erosion debris from the electrolyte prior to return to the spinning electrode. Suitable cooling of the electrolyte may also be provided to remove therefrom heat generated during the electroerosion process.

The two stage filters 58,60 can be joined in flow communication with the electrode 12 for effecting both internal and external flushing thereof to enhance the stability of the intermittent multiple electrical arcs generated at the tip end of the electrode during operation. Internal flushing is provided by channeling a portion of the electrolyte through the center bore of the electrode and out its tip end. And, external flushing is provided by channeling another portion of the electrolyte through the lower guide 48 as indicated above, while also optionally bathing the entire workpiece in the bath of electrolyte contained in the work tank 62.

The electroerosion apparatus includes the spinning electrode and its feedpath “P” that can be coordinated with control of the electrical power as illustrated schematically in FIG. 3. The power supply 22 can be configured for generating direct current (DC) voltage at about 20 to about 70 volts (V), which is typically greater than the voltage for ECM (typically less than 20 V) and generally less than the voltage range for EDM (typically greater than or equal to 80 V). Correspondingly, the power supply is further configured for generating relatively high electrical current (e.g., about 80 amps to about 750 amps), with a correspondingly high average current density (e.g., about 1,900 amps per square inch (amp/in²) to about 12,000 amp/in² (about 295 amps per square centimeter (amp/cm²) to 1,860 amp/cm²).

The relatively high current and average density thereof promote correspondingly large electroerosion material removal, with the additional advantage of relatively low peak current density of about 1,000 amp/in² (155 amp/cm²). The low peak current density is attributable to the multiple electrical arcs distributed over the entire cutting area of the electrode tip, as opposed to a single electrical arc. The low peak current density minimizes the production of the recast layer in the surface of the machine workpiece and prevents unacceptable heat affected damage thereto.

The low peak current density can be compared to the high peak current density of multiple orders of magnitude greater in EDM machining in the event of the generation of an electrical arc therein. In EDM, a dielectric liquid is used between the electrode and workpiece and promotes a single electrical discharge or arc in which the entire electrical current is dissipated. That single high current arc has the potential to cause significant damage unless it is avoided or terminated in its incipiency.

The power supply 22 illustrated in FIG. 3 is under the control of the controller 32 and can also be configured to have a DC voltage pulse train having a voltage on time in about 300 to about 3,000 microseconds (μsec). Correspondingly, the DC voltage pulse train can also have a voltage off time in about 10 to about 1,000 microseconds.

These pulse on and off times can be adjusted by the controller during the electroerosion process to control the generation of the intermittent multiple electrical arcs from the electrode tip alternating with electrical discharges without arcing. The alternating arcs and discharges can be balanced by maximizing the electroerosion removal rate while minimizing recast or heat affected surface layers on the workpiece.

The controller 32 can be configured for coordinating power to the spinning electrode 12 and the rate of movement or feed rate thereof across the workpiece for electroerosion machining the slot 36 at a machining rate exceeding about 1,500 cubic millimeters per minute, without undesirable thermal damage or recast layers in the workpiece.

For example, testing indicates a substantially high material removal rate for the exemplary superalloy Inconel 718 blisk workpiece of 4,200 mm³/min for an electrode with a peak current 280 amps and having a diameter of about 7.5 millimeters, with a corresponding frontal electrode area of 22 square millimeters (mm²). Testing additionally indicates a removal rate of greater than or equal to 10,000 mm³/min for an electrode having a 32 mm diameter, or, more specifically, greater than or equal to 20,000 mm³/min for the electrode having a 32 mm diameter under the peak current of 2,000 amps.

Compared with electrical discharge machining, as well as electrochemical machining, these material removal rates attributed to the distributed multiarc electroerosion process described herein are orders of magnitude greater in a stable process without undesirable heat affected damage to the workpiece.

The following examples are provided to further illustrate an embodiment of the reactor and are not intended to limit the broad scope of this application.

### EXAMPLES

### Example 1

TABLE 1

| | | Percentage |
|---|---|---|
| Constituent | Function | (wt %) |
| Triethanolamine | Anti-rusting | 8 |
| Sodium Molybdate | Anti-rusting | 8 |
| Potassium oleate | Anti-rusting | 6 |
| Potassium carbonate | Increasing conductivity | 6 |
| Silicone defoaming additive | Defoaming | 3 |
| Tri-Sodium Citrate | Lucent additive | 20 |
| Polyvinyl Alcohol | Burst additive | 8 |
| Emulsifier OP-10 | Surface-active medium | 1 |
| Pure water | Carrier | 34 |
| Indurstry oil 20# | Lubricant | 6 |

The constituents set forth in Table 1 were combined and mixed to form the electrolyte solution. The electrolyte was used in an electroerosion system such as that set forth in FIG. 3. A blisk of Inconel 718 (i.e., a high temperature nickel based alloy blisk) was processed using the developed electrolyte at a removal rate of 4,000 mm³/min at a current of 280 amps. The results show the advantages of the developed electrolyte formulation, namely, (i) improvement of the machined surface without the stuck particle (i.e., during the machining, no particles stick to the machined surface); (ii) a stable machining process without any tooling retracts (the tooling retract happens when there is consecutive short circuit between electrode and workpiece); and (iii) a reduced tool wear rate of 10% lower than a wear rate with a water based electrolyte used in a Wire EDM maching process. The water based electrolyte comprised aluminum, calcium, iron, copper, sodium, molybdenum, chromium, zinc, potassium, and phosphate, such as DX-4 commercially available from Nanjing Special Oil Factory, China.

### Example 2

TABLE 2

| | | Percentage |
|---|---|---|
| Components | Function | (wt %) |
| Triethanolamine | Anti-rusting | 7 |
| Sodium Molybdate | Anti-rusting, electrolyte | 7 |
| Tri-Sodium Citrate | Lucent additive, electrolyte | 15 |
| Polyvinyl Alcohol | Burst additive | 15 |
| Emulsifier OP-10 | Surface-active medium | 2 |
| Indurstry oil 20# | Lubricant | 5 |
| Potassium oleate | Increasing conductivity | 10 |
| Silicone defoaming agent | Defoaming | 1 |
| Pure water | Carrier | 38 |

The introduction of distributed multiple electrical arcs between the spinning electrode and the workpiece in the presence of an electrolyte therebetween permits a substantial increase in the material removal rate of the electroerosion process which substantially exceeds the material removal rates of EDM and ECM processes. Where those latter processes intentionally prohibit electrical arcing between the electrode and workpiece, the distributed arc process disclosed above preferentially introduces multiple electrical arcs with high average current density (e.g., greater than or equal to about 5 amps/mm²) for maximizing material removal rate. Generally the current density is about 5 amps/mm² to about 50 amps/mm².

Accordingly, electroerosion of the workpiece can be attained more quickly than previously possible, without undesirable damage thereto. The electrolyte and process enable a reduction in both the time and expense associated in the manufacture of the workpiece, which is particularly significant for complex and expensive workpieces such as the exemplary gas turbine engine rotor blisk disclosed above. The present electrolyte and process allows a removal rate of greater than or equal to about 2,500 mm³/min at a peak current of 280 amps, to produce a surface free from craters or gouging having a size of greater than or equal to 1.5 mm in diameter and 0.8 mm in depth; wherein the prior art process, at a rate of 2,000 mm³/min at a peak current of 200 amps, produced a surface having craters and gouging having a size of 3.5 mm in diameter and 2 mm in depth. (It is noted that generally, for EDM machine tool, the peak current is less than 200 amps, open voltage is higher than 80 volts (V), for Wire Electrical discharge machining (WEDM), the peak current is less than 50 amps and the open voltage is higher than 80 V.)

Ranges disclosed herein are inclusive and combinable (e.g., ranges of “up to about 25 wt %, or, more specifically, about 5 wt % to about 20 wt %”, is inclusive of the endpoints and all intermediate values of the ranges of “about 5 wt % to about 25 wt %,” etc.). “Combination” is inclusive of blends, mixtures, alloys, reaction products, and the like. Furthermore, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the state value and has the meaning dictated by context, (e.g., includes the degree of error associated with measurement of the particular quantity). The suffix “(s)” as used herein is intended to include both the singular and the plural of the term that it modifies, thereby including one or more of that term (e.g., the colorant(s) includes one or more colorants). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements can be combined in any suitable manner in the various embodiments.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While the invention has been described with reference to a preferred embodiment, it will be understood by those skilled in the art that various changes can be made and equivalents can be substituted for elements thereof without departing from the scope of the invention. In addition, many modifications can be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An electroerosion apparatus comprising:
an electrode;
a multiaxis machine comprising a tool head configured to support and to spin the electrode, and a spindle configured to support a workpiece;
an electrolyte supply including a conduit for circulating an electrolyte, wherein the electrolyte comprises an anti-rusting agent, a defoaming agent, a lucent additive, a burst additive, a surface active medium, a lubricant, and water, and has a conductivity of about 0.1 milliSiemens to about 30 milliSiemens; and
a controller in operative communication with the multiaxis machine and configured for distributing intermittent multiple electrical arcs between the electrode and a workpiece.

2. The apparatus of claim 1, wherein the electrolyte comprises a weight ratio of water to electrolyte composition of about 50:1 to about 15:1, and wherein the electrolyte composition comprises an amount of the anti-rusting additive of about 8 wt % to about 35 wt %, an amount of the defoaming agent of about 1 wt % to about 5 wt %, an amount of the lucent additive of about 5 wt % to about 30 wt %, an amount of the burst additive of about 5 wt % to about 20 wt %, an amount of the surface active medium of about 0.5 wt % to about 5 wt %, an amount of the lubricant of about 1 wt % to about 20 wt % lubricant(s), balance water, based upon a total weight of the electrolyte composition.

3. The apparatus of claim 2, wherein the electrolyte composition comprises about 5 wt % to about 10 wt % a triethanolamine, about 0.5 to about 2 wt % sodium perborate, about 5 to about 10 wt % sodium molybdate, about 4 to about 8 wt % potassium oleate, about 4 to about 8 wt % potassium carbonate, about 2 wt % to about 5 wt % silicone defoaming agent, about 15 wt % to about 20 wt % tri-sodium citrate, about 5 wt % to about 10 wt % polyvinyl alcohol, about 0.5 wt % to about 2 wt % emulsifier, about 5 wt % to about 8 wt % industrial oil, balance water, based upon a total weight of the composition.

4. The apparatus of claim 3, wherein the emulsifier comprises C₈H₁₇C₆H4O(CH₂CH₂O)10H.

5. The apparatus of claim 1, wherein the conductivity is about 0.1 milliSiemens to about 5 milliSiemens.

6. The apparatus of claim 1, wherein the conductivity is about 0.1 milliSiemens to about 15 milliSiemens.

7. The apparatus of claim 1, wherein the apparatus is configured such that, when the machining is performed at a rate of greater than or equal to about 2,000 mm³/min under the condition of peak current 280 amps, a resulting machined surface will be free from defects having a size of greater than or equal to 2 mm in diameter and 1 mm in depth, wherein the diameter is measured across the major axis and the depth is a maximum depth of the defect.

8. The apparatus of claim 7, wherein the rate is greater than or equal to about 4,000 mm³/min, and wherein the machined surface is free from the defects having a size of greater than or equal to 1.5 mm in diameter and 0.8 mm in depth.

9. The apparatus of claim 1, wherein the conduit is configured to circulate the electrolyte through the electrode.

10. A method of electroerosion machining a workpiece, comprising:
creating relative motion between a spinning electrode and a workpiece;
circulating an electrolyte around the spinning electrode, wherein the electrolyte comprises an anti-rusting agent, a defoaming agent, a lucent additive, a burst additive, a surface active medium, a lubricant, and water, and has a conductivity of about 0.1 milliSiemens to about 30 milliSiemens; and
distributing multiple electrical arcs between the electrode tip and the workpiece;
wherein, when the machining is performed at a rate of greater than or equal to about 2,000 mm³/min under the condition of peak current 280 amps, the resulting machined surface will be free from defects having a size of greater than or equal to 2 mm in diameter and 1 mm in depth, wherein the diameter is measured across the major axis and the depth is a maximum depth of the defect.

11. The method of claim 10, further comprising circulating the electrolyte through the spinning electrode to an electrode tip located adjacent the workpiece.

12. The method of claim 10, wherein the rate is greater than or equal to about 3,000 mm³/min.

13. The method of claim 12, wherein the rate is greater than or equal to about 4,000 mm³/min.

14. The method of claim 13, wherein the current density is greater than or equal to about 5 amps/mm².

15. The method of claim 10, wherein the machined surface is free from the defects having a size of greater than or equal to 1.5 mm in diameter and 0.8 mm in depth.
